(19) United States
(12) Patent Application Publication
(10) Pub. No.: US 2025/0105320 A1
(43) Pub. Date: Mar. 27, 2025

(54) DYNAMIC FUEL CELL STACK SWITCHING

(71) Applicant: ZeroAvia Ltd, Cirencester (GB)

(72) Inventors: Aleksandr KIKHTENKO, Cirencester (GB); Gareth COATES, Cirencester (GB); Pablo DE FELIPE, Cirencester (GB); Bob L. MACKEY, Hollister, CA (US); Julia DI, Hollister, CA (US)

(21) Appl. No.: 18/891,534

(22) Filed: Sep. 20, 2024

Related U.S. Application Data
(60) Provisional application No. 63/540,008, filed on Sep. 22, 2023.

(51) Int. Cl. H01M 8/04302; H01M 8/04492; H01M 8/04537; H01M 8/04828; H01M 8/04858

(52) U.S. Cl. CPC H01M 8/04302; H01M 8/04492; H01M 8/04559; H01M 8/04828; H01M 8/0488; H01M 2250/20

(57) ABSTRACT

A method and system of dynamic fuel cell stack switching includes monitoring a fuel cell voltage of a hydrogen fuel cell stack system. When the fuel cell voltage is outside a voltage range, the fuel cell voltage is adjusted by electrically bypassing at least one fuel cell stack within the hydrogen fuel cell stack system, or by electrically connecting the at least one fuel cell stack to the hydrogen fuel cell stack system. For a bypassed fuel cell stack, a hydration level of the electrically bypassed fuel cell stack is monitored.

### CROSS REFERENCE TO RELATED APPLICATION

This application claims benefit to U.S. Provisional Patent Application Ser. No. 63/540,008, filed Sep. 22, 2023, the contents of which are incorporated herein by reference in its entirety.

### FIELD OF THE DISCLOSURE

The present disclosure relates to operational management of fuel cells. The disclosure has particular utility in the case of PEM (Proton Exchange Membrane) fuel cell systems such as hydrogen fuel cells onboard vehicles including aircraft and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features. A fuel cell is an electrochemical cell that converts chemical energy into electrical energy by spontaneous electrochemical reduction-oxidation (redox) reactions. Fuel cells include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that must be removed from the fuel cell.

Fuel cells may be used as power sources for electric motors of electric vehicles and hybrid electric vehicles, including aircraft. In such applications, fuel cells oftentimes are arranged in stacks of multiple cells and connected in a series or parallel arrangement to achieve a desired power and output voltage.

In fuel cell-powered aircraft, the power output demanded of the fuel cells varies widely over flight phase, from startup to shutdown. Power demand is greatest during take-off and climb. 100% power output is only needed for 60-120 seconds on takeoff and initial climb to 1,000 feet. After 1,000 feet, power may be reduced by 20% for the normal climb portion of the flight. Power demands are even lower at steady cruise, approach, go around, descent, taxiing and idling. A low current drawn from a fuel cell system result in a substantially higher than nominal output voltage. The high-voltage inverters commonly used on aircraft are rated for a 650-850 V DC/DC input voltage range, which is considerably less than the voltage range that a fuel cell stack system, composed of fuel cell stacks connected electrically in series, may output. For example, a fuel cell aircraft could see voltages above 1 kV in periods of low power output that may occur during startup, taxiing and idling, as well as during a throttle-back condition in flight. Operating fuel cells at excessive voltages reduces the operational life of inverters and the fuel cells. While dump load resistors may be employed to level output voltages, dump load resistors add cost, weight and volume to the system.

When a fuel cell stack is switched out of series circuit, an electrically bypassed fuel cell will still have reactant delivered since it is still chemically within the circuit. Under such conditions it becomes important to monitor hydration levels of the bypassed stack.

More particularly, when a fuel cell stack is switched out of a series circuit, it can be switched into parallel in another fuel cell stack in the system. This allows the fuel cell stack to continue operating at half the required current. Operating at a lower current may be sufficient to maintain stable hydration states, while also reducing current density, increasing efficiency, and prolonging fuel cell stack.

In another embodiment, a fuel cell stack may be switched out of series circuit and connected to a load circuit. The load circuit may serve other aircraft power needs, or simply as a resistor. The current used in the load circuit is sufficient to maintain the fuel cell stack in a “warm standby” state, ready for essentially immediate transition back to high power production.

In some embodiments where there are multiple possible parallel and series configurations of the system, a controller may be used to determine when to switch between a more parallel and more series configuration. The controller may be responsive to flight phase with different sustained power requirements depending on the particular flight phase, e.g., taxiing, acceleration to take-off, steady climb, steady cruise, steady descent, approach, go around and final approach. During periods of low current draw, solid-state or electro-mechanical switches can be used to dynamically switch some fuel cell stacks electrically out of the circuit. For fuel cell stacks that are electrically switched out of the circuit but remain chemically within the same circuit, hydration levels are monitored and controlled to ensure stack health.

Switching some fuel cells electronically out of the circuit allows high voltage series fuel cell stacks to be used with cost-effective inverters without introducing additional dump load resistors (extra weight and volume) or presenting excessive input voltage (reduces operational lifespan of inverters).

In the following figures, a superstack system of four fuel cell stacks in series is depicted but the invention can be used for n number of fuel cell stacks. A sample operation is shown where three fuel cell stacks form a stack system that is sized to the aircraft's periods of low current draw, providing the requisite minimum power necessary to maintain operation of the plane. When there is a period of high current draw, a fourth fuel cell stack may be electrically switched into the circuit to provide the requisite power within the inverter input voltage range.

In one embodiment, the present disclosure can be viewed as providing methods of dynamic fuel cell stack switching. In this regard, one embodiment of such a method, among others, can be broadly summarized by the following steps: monitoring a fuel cell voltage of a hydrogen fuel cell stack system; and when the fuel cell voltage is outside a voltage range, adjusting the fuel cell voltage by: electrically bypassing at least one fuel cell stack within the hydrogen fuel cell stack system; or electrically connecting the at least one fuel cell stack to the hydrogen fuel cell stack system.

In one aspect, when the at least one fuel cell stack is electrically bypassed within the hydrogen fuel cell stack system, a hydration level of the electrically bypassed at least one fuel cell stack is monitored.

In this aspect, monitoring the hydration level of the electrically bypassed at least one fuel cell stack further comprises: determining the hydration level relative to a hydration threshold; and when the hydration level is less than the hydration threshold, executing a hydration recovery procedure.

In another aspect, the hydrogen fuel cell stack system further comprises fuel cell stacks electrically connected in series, where electrically bypassing at least one of the fuel cell stacks within the hydrogen fuel cell stack system removes the at least one fuel cell stack from being electrically connected in series.

In yet another aspect, electrically bypassing the at least one fuel cell stack within the hydrogen fuel cell stack system or electrically connecting the at least one fuel cell stack to the hydrogen fuel cell stack system further comprises switching the at least one fuel cell stack out of or into the hydrogen fuel cell stack system, respectively, using at least one solid-state or electro-mechanical switch.

In another aspect, bypassing the at least one fuel cell stack occurs during a period of low current draw.

In this aspect, the hydrogen fuel cell stack system powers an aircraft, and the period of low current draw further comprises at least one of: during startup, during taxiing, during idling, or during a throttle-back condition in flight.

In another aspect, the at least one fuel cell stack is switched into a second hydrogen fuel cell stack system when the at least one fuel cell is electrically bypassed from the hydrogen fuel cell stack system, where the at least one fuel cell stack is connected electrically in parallel to the second hydrogen fuel cell stack system.

In yet another aspect, the at least one fuel cell stack is switched into a load circuit when the at least one fuel cell stack is electrically bypassed from the hydrogen fuel cell stack system.

In yet another aspect, the hydrogen fuel cell stack system powers an aircraft, and the method further comprises: identifying a sustained power requirement of the aircraft; and using a controller, activating a switching of the at least one fuel cell stack to a predetermined electrical configuration which is responsive to the identified sustained power requirement of the aircraft.

The present disclosure can also be viewed as providing a system for dynamic fuel cell stack switching. Briefly described, in architecture, one embodiment of the system, among others, can be implemented as follows. A hydrogen fuel cell stack system has a plurality of fuel cell stacks. A voltage monitoring sensor monitors a fuel cell voltage of the hydrogen fuel cell stack system. A switch is in electrical communication with the hydrogen fuel cell stack system, wherein when the fuel cell voltage is outside a voltage range, the switch is activated to: electrically bypass at least one fuel cell stack within the hydrogen fuel cell stack system; or electrically connect the at least one fuel cell stack to the hydrogen fuel cell stack system.

In one aspect, a hydration sensor is in communication with the electrically bypassed at least one fuel cell stack, wherein when the at least one fuel cell stack is electrically bypassed within the hydrogen fuel cell stack system, the hydration sensor monitors a hydration level of the electrically bypassed at least one fuel cell stack.

In this aspect, the hydration sensor senses the hydration level relative to a hydration threshold, and wherein, when the hydration level is less than the hydration threshold, a hydration recovery procedure is executed.

In another aspect, the plurality of fuel cell stacks of the hydrogen fuel cell stack system are electrically connected in series, and wherein electrically bypassing the at least one of the fuel cell stacks within the hydrogen fuel cell stack system removes the at least one fuel cell stack from being electrically connected in series.

In yet another aspect, the switch further comprises at least one solid-state or electro-mechanical switch.

In another aspect, the fuel cell voltage is outside the voltage range during a period of low current draw.

In this aspect, the hydrogen fuel cell stack system powers an aircraft, and wherein the period of low current draw further comprises at least one of: during startup, during taxiing, during idling, or during a throttle-back condition in flight.

In another aspect, a second hydrogen fuel cell stack system is included, where the switch is activated to electrically bypass at least one fuel cell stack within the hydrogen fuel cell stack system and electrically connect, in parallel, the at least one fuel cell stack to the second hydrogen fuel cell stack system.

In yet another aspect, the switch is activated to electrically bypass at least one fuel cell stack within the hydrogen fuel cell stack system and electrically connect the at least one fuel cell stack to a load circuit.

In yet another aspect, using machine learning algorithms, inflight data and current and next flight data, period of low current draw can be predicted.

In another aspect, the hydrogen fuel cell stack system powers an aircraft, and further comprises at least one controller, wherein the controller activates switching of the at least one fuel cell stack to a predetermined electrical configuration which is responsive to an identified sustained power requirement of the aircraft.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a graphical illustration of an output voltage of a fuel cell stack system used with a method and system of dynamic fuel cell stack switching, in accordance with the present disclosure;

FIG. 2 is a diagrammatical illustration of a system of dynamic fuel cell stack switching, in accordance with the present disclosure;

FIG. 3 is a circuit diagram of a system of dynamic fuel cell stack switching, in accordance with the present disclosure;

FIGS. 4-5 are graphical illustrations of a voltage transition in one example of a system of dynamic fuel cell stack switching, in accordance with the present disclosure;

FIG. 6 is a flowchart of a method of dynamic fuel cell stack switching, in accordance with the present disclosure;

FIG. 7 is a diagrammatical illustration of a method and system of dynamic fuel cell stack switching, in accordance with the present disclosure;

FIG. 8 is a circuit diagram of one example of the system of dynamic fuel cell stack switching, in accordance with the present disclosure;

FIG. 9 is a circuit diagram of the example of the system of dynamic fuel cell stack switching of FIG. 8, in accordance with the present disclosure;

FIG. 10 is a diagrammatical illustration of the example of the system of dynamic fuel cell stack switching of FIG. 8, in accordance with the present disclosure;

FIG. 11 is an illustration of an implementation of flight phase prediction using a supervised machine learning method on training data, in accordance with the present disclosure; and

FIG. 12 is a flowchart 100 illustrating a method of dynamic fuel cell stack switching in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

To improve over the shortcomings in the industry, the present disclosure is directed to methods and systems for dynamic fuel cell stack switching which can be used to dynamically switch some fuel cell stacks electrically out of a fuel cell stack system during certain periods of operation, such as during periods of low current draw. This may allow for high voltage series fuel cell stacks to be used with cost-effective inverters without introducing additional dump load resistors, which commonly add extra weight and volume to the limited spatial capacity of an aircraft, and without presenting excessive input voltage, which reduces operational lifespan of inverters. Fuel cell stacks that are electrically switched out of the fuel cell stack system's circuit remain chemically within the same circuit. As such, hydration levels of the switched fuel cell stacks may be monitored to ensure stack health.

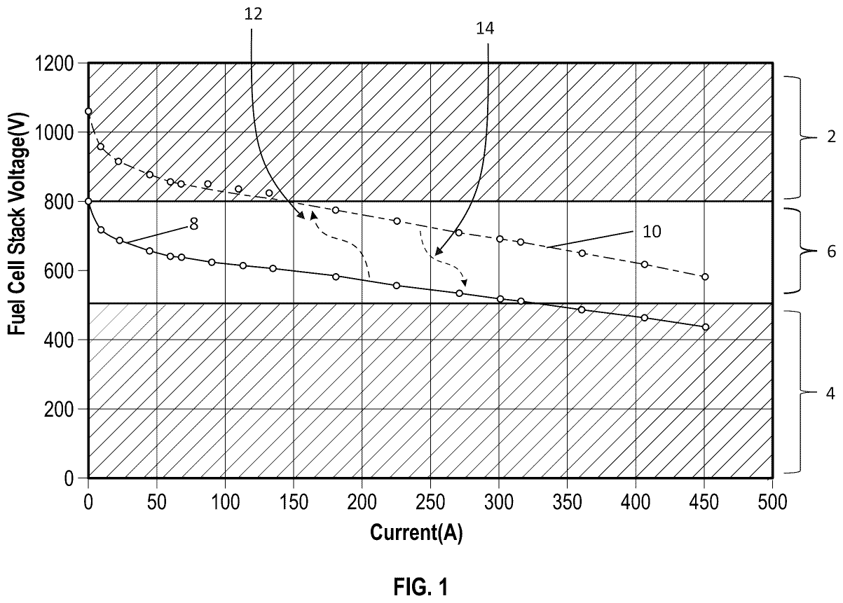

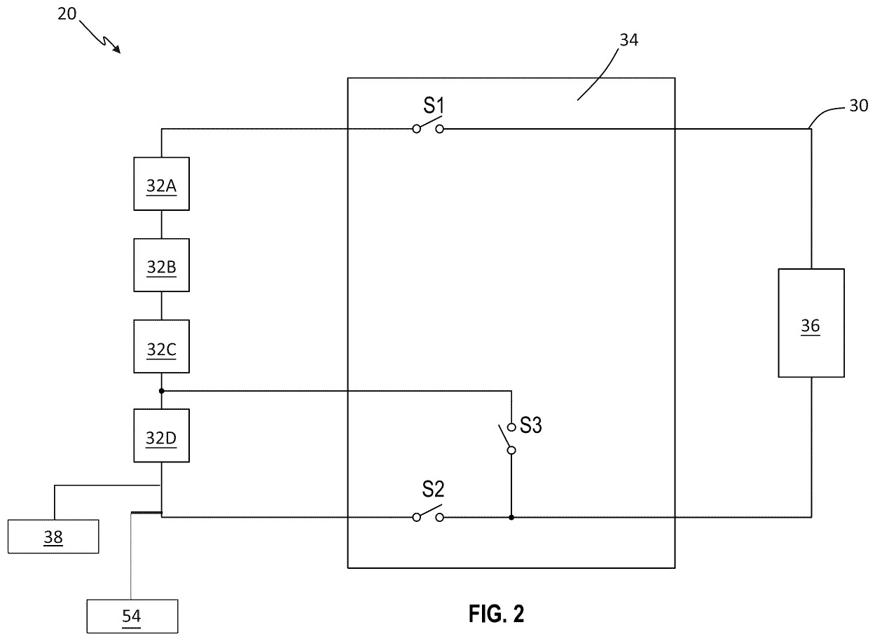

In greater detail, FIG. 1 is a graphical illustration of an output voltage of a fuel cell stack system used with a method and system of dynamic fuel cell stack switching, and FIG. 2 is a diagrammatical illustration of a system of dynamic fuel cell stack switching 20, in accordance with the present disclosure. With reference to FIG. 1, the graph depicts the output voltage of a fuel cell stack system when the invention is in operation. Shaded regions 2, 4 represent the out-of-bounds input voltage range of the high-voltage inverters, while region 6 represents the desired input voltage range of high-voltage inverters, such that the boundaries between region 6 and regions 2 and 4 generally define the upper and lower limits of the desired voltage range.

Line 8 plots the output voltage of an exemplary system which has three fuel cell stacks. As power is pulled and the current increases, the voltage decreases close to the out-of-bounds, lower range at the location where line 8 enters out-of-bounds region 4, which occurs around 120 A current draw. At this point, the fuel cell voltage may be adjusted by electrically introducing a fourth fuel cell stack into the system, which acts to increase the output voltage to stay within the inverter input range of region 6. Specifically, electrically connecting the fourth fuel cell stack adjusts the voltage to the plot of line 10, which increases the voltage to be near the upper limit of desired region 6, such that continued operation of the fuel cell stack system can occur within this desired region 6 of the inverter input range. The introduction of the fourth fuel cell stack system, which causes the change in voltage, is depicted by arrow 12. If the system is operating at constant power during that transition, the voltage increase is accompanied by a proportional current decrease. Similarly, arrow 14 depicts a transition from four fuel cell stacks to three fuel cell stacks, resulting in a decreased voltage and increased current.

FIG. 2 illustrates an exemplary fuel cell system with which the system for dynamic fuel cell stack switching 20 (hereinafter, “system 20”) is used. As shown, a hydrogen fuel cell stack system 30 has a plurality of fuel cell stacks 32A-32D which are connected via switch S1 to a high voltage power box 34 and to an electrical load 36. The plurality of fuel cell stacks 32A-32D includes, in this example, four fuel cell stacks, 32A, 32B, 32C, and 32D. The first three fuel cell stacks 32A-32C are connected in series with one another, while the fourth fuel cell stack 32D is connectable either in series with the other fuel cell stacks 32A-32C or bypassed, as may be controlled by switches S2 and S3. Each fuel cell stack 32A-32D with switching capability has switching circuitry and a voltage monitoring sensor 38, while fuel cell stack 32D has switching capability implemented. The voltage monitoring sensor 38 may be implemented in each fuel cell stack separately, or a single voltage monitoring sensor 38 may be used connected to the hydrogen fuel cell stack system 30, either generally or to a particular component thereof.

In use, the voltage monitoring sensor 38 monitors a fuel cell voltage of the hydrogen fuel cell stack system 30 to determine if the fuel cell voltage is outside of the voltage range, such as the range described relative to FIG. 1. The sensor 38 may also monitor current output. If a voltage reading is beyond the desired voltage range, this may be indicated as an unsafe operation range by use of an out-of-bounds signal. When this occurs, switches S2 or S3 may be activated to dynamically adjust the voltage, such as by either electrically bypassing at least one fuel cell stack within the hydrogen fuel cell stack system 30, e.g., fuel cell stack 32D depicted in FIG. 2, or to electrically connect the at least one fuel cell stack 32D to the hydrogen fuel cell stack system 30. This allows for dynamically switching fuel cell stacks 32A-32D into or out of a power generation circuit using at least one solid-state or electro-mechanical switch, which may include various types of electromechanical relays or solid-state electronics.

As an example, if the voltage reading is exceeding the voltage range 6, the system 20 may open switch S2 and close switch S3 to electrically bypass fuel cell stack 32D from the remaining fuel cell stacks within the hydrogen fuel cell stack system 30, which will lower the voltage from the hydrogen fuel cell stack system 30. In this case, the plurality of fuel cell stacks 32A-32D of the hydrogen fuel cell stack system 30 are electrically connected in series, and wherein stack 32D is electrically bypassed, it is removed from being connected electrically in series to the remaining stacks 32A-32C. In one of many alternatives, if the voltage reading is nearing the bottom range of the voltage range, the system 20 may close switch S2 and open switch S3 to electrically connect fuel cell stack 32D to the remaining fuel cell stacks within the hydrogen fuel cell stack system 30, which will increase the voltage from the hydrogen fuel cell stack system 30, as described relative to FIG. 1.

While FIGS. 1-2 describe an exemplary superstack system 20 which uses three to four fuel cell stacks, it is noted that any n number of fuel cell stacks may be used in practice. FIG. 2 depicts a sample operation where three fuel cell stacks form a stack system that is sized to an aircraft's periods of low current draw, providing the requisite minimum power necessary to maintain operation of the plane. When there is a period of high current draw, a fourth fuel cell stack may be electrically switched into the circuit to provide the requisite power within the inverter input voltage range. The fourth fuel cell may be electrically switched out of the circuit to accommodate periods of low current draw. A period of low current draw may include, for example, during startup, during taxiing, during idling, or during a throttle-back condition in flight.

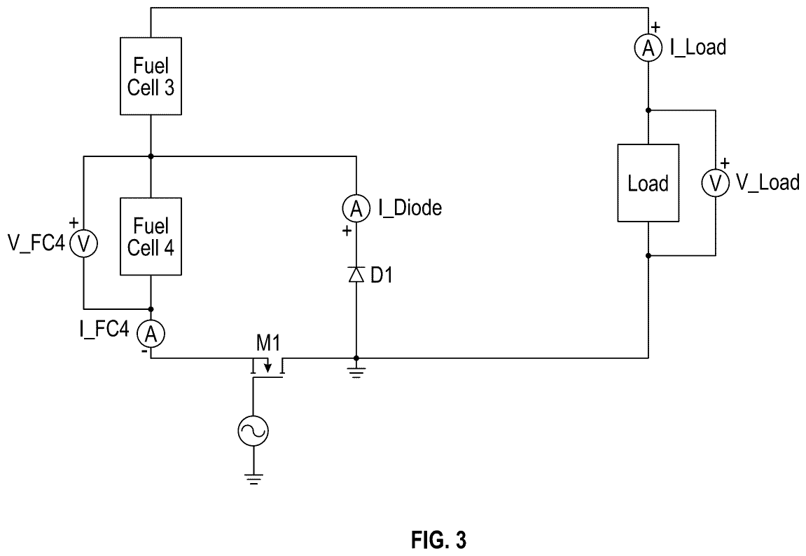

FIG. 3 is a circuit diagram of the system 20, in accordance with the present disclosure. As shown, FIG. 3 depicts one implementation of switching circuitry comprised of a reverse-biased diode and a solid-state switch. When the solid-state switch is open, the diode is forward-biased allowing current flow to bypass the fourth fuel cell stack. When the solid-state switch is closed, the diode is reverse-biased allowing current to flow into the fuel cell stack. The switch may be electro-mechanical in other implementations.

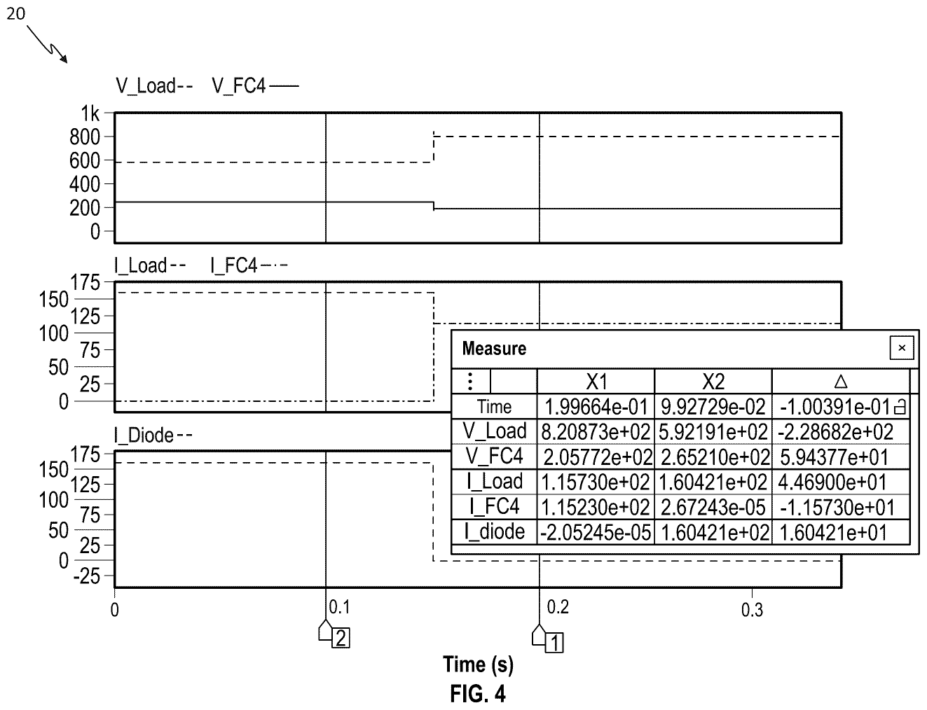

FIGS. 4-5 are graphical illustrations of a voltage transition in one example of the system 20. In particular, FIGS. 4-5 depict the voltage transition in the example provided in FIGS. 1-2, where the system 20 transitions from three fuel cell stacks to four fuel cell stacks for an ideal diode and a non-ideal diode. The introduction of the fourth stack may be ramped when the amount of gas in the stack is not sufficient to generate the requested current, since instantaneous delivery of fluidics is not possible. A ramp generator circuit may be used for a linear current ramp rate.

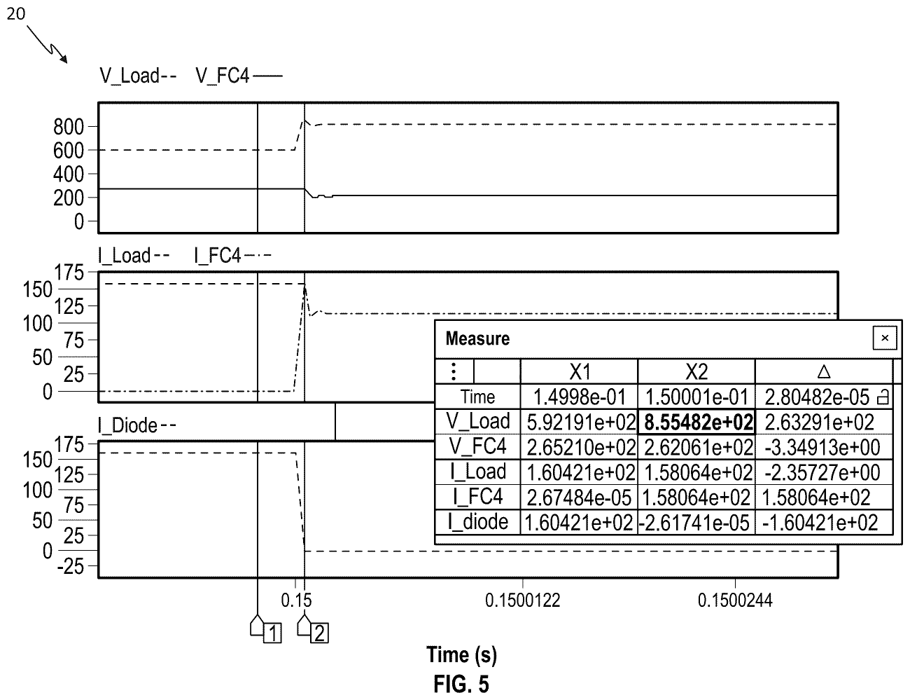

FIG. 6 is a flowchart 40 of a method of dynamic fuel cell stack switching, in accordance with the present disclosure, which describes a switching schema for aircraft usage that includes electrical switching of fuel cell stacks. The voltage and current draw of the fuel cell stack system may be continuously monitored, as shown at block 42. When the fuel stack system voltage is outside a predefined range or threshold of inverter input range (block 44), one or more of the fuel cells is adjusted (block 46), such as by being bypassed, connected, or reconnected, depending on the voltage adjustment needed. In the case of FIG. 6, when a fuel cell stack is bypassed, it may later be added or reconnected. To this end, when the fuel cell stack system is monitored to have a voltage that is within the range or threshold (block 48), the fuel cell may be electrically reconnected (block 50). It is worth noting that instantaneously switching a fuel cell stack into or out of a circuit would introduce a large voltage change and could drive excessive currents, possibly damaging electrical components. This can be avoided by using a pre-charge resistor, as is commonly understood by electrical engineers working with batteries or capacitive circuits. Implementation of a pre-charge circuit allows the high-current switches to be switched with little voltage across them, thus protecting the system from damage and extending lifespan.

In some implementations, an electrically bypassed fuel cell stack will still have reactants delivered if it is still chemically within circuit of the fuel cell stack system. As such, it may be important to monitor the hydration levels of the bypassed stack to ensure maintained fuel cell stack health. To this end, FIG. 6 depicts subroutine 52 for monitoring the hydration level of a bypassed fuel cell stack, and FIG. 2 depicts a hydration sensor 54 that is in communication with the electrically bypassed fuel cell stack. When the fuel cell stack is electrically bypassed within the hydrogen fuel cell stack system, the hydration sensor 54 monitors a hydration level of the electrically bypassed at least one fuel cell stack (block 56) The hydration sensor 54 senses the hydration level relative to a hydration threshold (block 58), and when the hydration level is less than the hydration threshold, a hydration recovery procedure is executed (block 60).

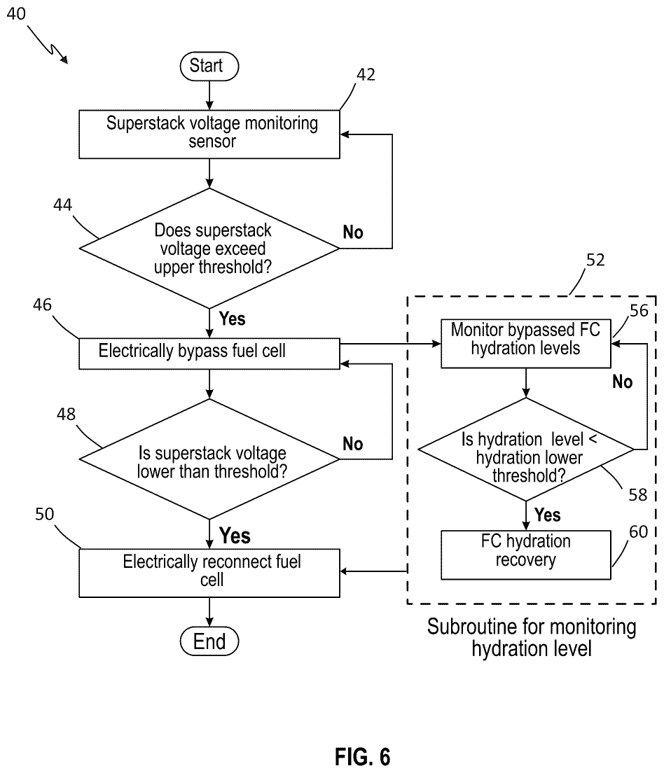

FIG. 7 is a diagrammatical illustration of a method and system of dynamic fuel cell stack switching, in accordance with the present disclosure, which depicts a method of monitoring fuel cell stack health when the stack is bypassed. Hydration levels of the fuel cell stacks 32A-32D may be constantly monitored with a probe 70 and may be used as inputs into logic state controller 72. Sensors, such as a stack electrochemical impedance spectroscopy (EIS) controller, may be used to determine when a fuel cell stack 32A-32D may be electrically switched in or out from the circuit. Determination may be based on predefined hydration thresholds and operating voltage requirements. Electrochemical impedance measurements with a high-frequency and low-frequency perturbation may be used to monitor hydration levels.

It is noted that the system 20 may utilize any additional number of hydrogen fuel cell stack systems, where a fuel cell stack circuit may be switched to bypass one hydrogen fuel cell stack system and electrically connect the fuel cell stack in parallel to another hydrogen fuel cell stack system. In particular, when a fuel cell stack is switched out of the series circuit, it can be switched into parallel with another fuel cell stack in the system. This allows the fuel cell stack to continue operating at half the required current. Operating at lower current may be sufficient to maintain stable hydration states, while also reducing current density, increasing efficiency, and prolonging fuel cell stack longevity. This technique can be used as an alternative configuration for ensuring hydration levels in a bypassed fuel cell stack, especially if the hydration level is to be sustained for longer periods of time (i.e., several minutes).

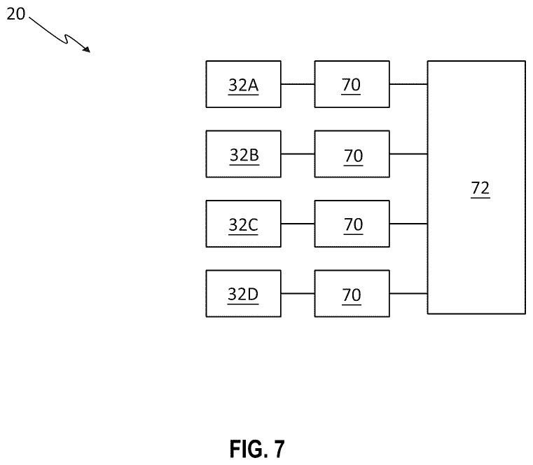

FIG. 8 is a circuit diagram of one example of dynamic fuel cell stack switching, which depicts two fuel cell stacks (FC1 and FC2), and how each fuel cell stack can be connected in series or in parallel with a neighboring fuel cell. In series operation, the NC switches are closed, and the NO switches are open. In parallel operation, the switch positions are reversed. All switches are connected to a single controller so that their relative timing can be controlled. Switching should be break-before-make to avoid temporary short-circuit conditions.

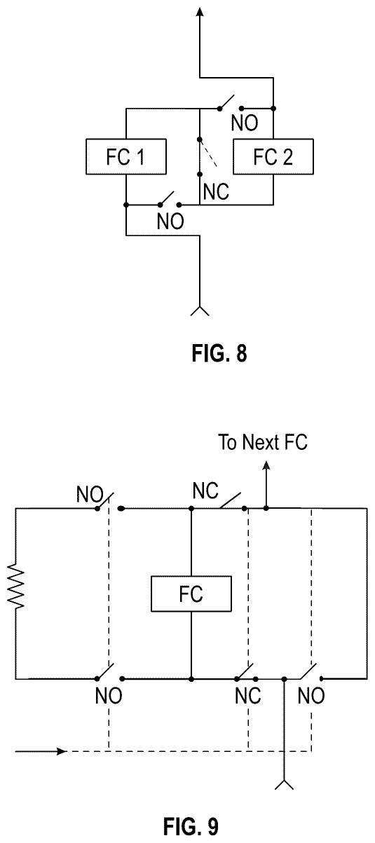

When a fuel cell stack is switched out of the series power circuit, it may be connected to a load circuit. The load circuit may serve other aircraft power needs or simply as a resistor. The current used in the load circuit is sufficient to maintain the fuel cell stack in a “warm standby” state, ready for immediate transition back to high power production. FIG. 9 is a circuit diagram of this example where each fuel cell in a stack can be independently switched into the series power circuit, or bypassed by the main power circuit and (optionally) connected to conditioning maintenance load.

In some embodiments where there are multiple possible parallel and series configurations of the system, a controller is used to determine when to switch between a more parallel and more series configuration. This controller may be based on flight phase and may be advantageous in the case where the power setting needs to be sustained, either predictively to anticipated flight conditions or reactively to sensed or determined flight conditions. For example, a descent from 25,000 feet to sea level at 1000 fpm continues for 25 minutes. The controller, responsive to flight phase voltage requirements or anticipated flight voltage conditions, may calculate which specific fuel cell stack configurations in series and parallel such that the desired voltage condition can be achieved. Some examples of flight phases with different sustained power requirements include: taxiing, acceleration to takeoff, steady climb, steady cruise, steady descent, approach, go around, and final approach and/or various subcategories of these.

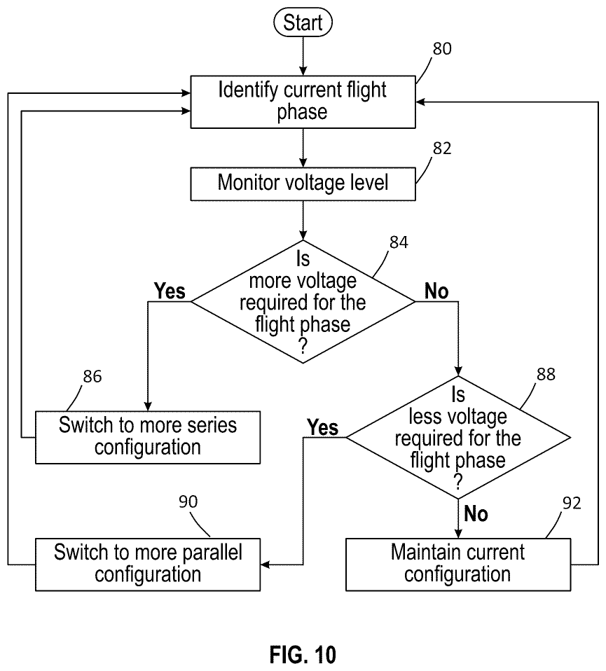

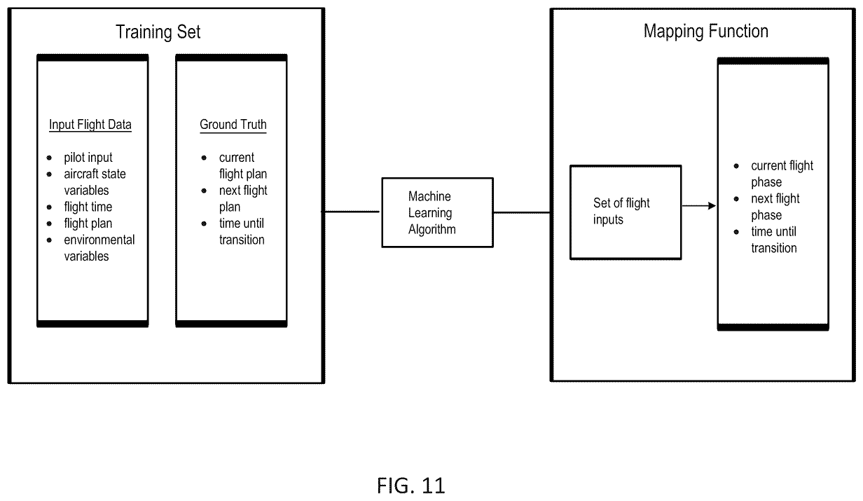

FIG. 10 is a diagrammatical illustration of an example of a technique for controlling stack configuration based on flight phase. As shown, the system may identify the current flight phase (at block 80) and monitor the voltage level (block 82). If more voltage is required for a particular flight phase (block 84), the system may switch to more series configurations of the fuel cell stacks (block 86). If less voltage is required for the particular flight phase (block 88), the system may switch to more parallel configurations of the fuel cell stacks (block 90). If neither more or less voltage is required, the system may maintain the current fuel stack configuration (block 92) and continue identifying the flight phase and monitoring the voltage level. To determine the next sustained flight phase, flight phase prediction may be implemented with data-driven methods using a combination of inputs. These inputs may include pilot input, sensed aircraft state variables (including altitude, speed, rate of climb, X-Y coordinates, roll, pitch, heading, fuel levels, and/or power levels), flight time, flight plan, environmental variables (including weather, temperature, visibility), variable history, and state history. These inputs can be specific to a single flight trajectory or a group of flight trajectories. By way of example, but not limitation, machine learning methods may be used to implement flight phase prediction. Another example may use logic conditions and probability functions. FIG. 11 is an illustration of an implementation of flight phase prediction using a supervised machine learning method on training data. A training dataset may be obtained with the combination of inputs from simulation or historical data. The combination of inputs is paired with ground truth data that may be generated with a neural network, modeled or labeled by a human expert, or a combination of two or more of neural networks, modeled or labeled. A machine learning algorithm may be applied on the training set to learn a mapping between a combination of inputs and the current flight phase, next flight phase, and time left until phase transition. This mapping function may comprise a table that maps the combination of flight inputs to current flight phase, predicted flight phase, and time left until phase transition. During the actual flight of the aircraft, onboard sensor data and aircraft state information may be repeatably retrieved to use as inputs for the mapping function, and the flight phase prediction may be done by searching the tabulated mapping function using an onboard processor. When an exact match is not found, an interpolation process may be used to determine the best fit. This method may be augmented by additionally learning the desired sustained power level as an output to optimize for energy savings and fuel cell longevity.

FIG. 11 illustrates how flight data such as pilot input, aircraft state variables, flight time, flight plan and environmental variables (weather, temperature, wind speed, wind direction, etc.) and ground truth such as current flight plan, next flight plan, and time to transition can be employed to predict the period of low current draw, using a machine learning algorithm, which in turn permits us to operate at higher efficiencies by bypassing one or more fuel stacks during periods of low current draw. The operational life of components also may be extended.

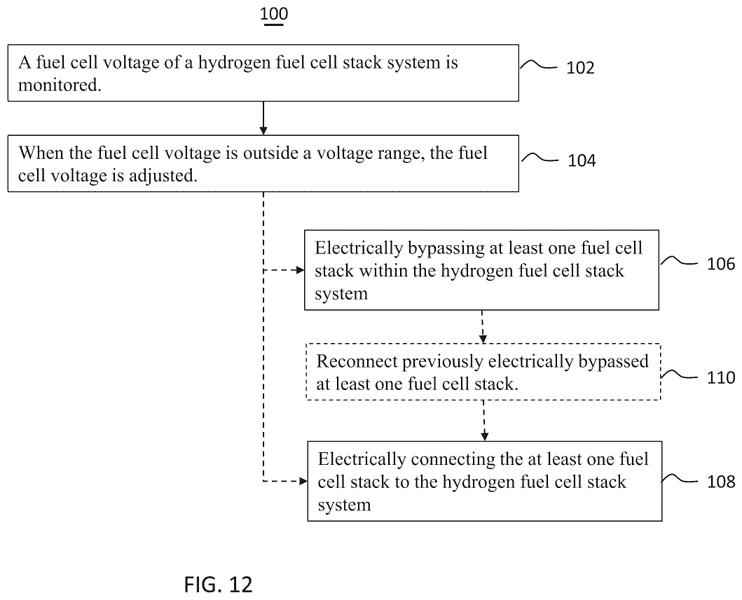

FIG. 12 is a flowchart 100 illustrating a method of dynamic fuel cell stack switching in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrent or in reverse order, depending on the functionality involved, as would be understood by those reasonably skilled in the art of the present disclosure.

As is shown by block 102, a fuel cell voltage of a hydrogen fuel cell stack system is monitored. When the fuel cell voltage is outside a voltage range, the fuel cell voltage is adjusted (block 104) by: electrically bypassing at least one fuel cell stack within the hydrogen fuel cell stack system (block 106); or electrically connecting the at least one fuel cell stack to the hydrogen fuel cell stack system (block 108). Additionally, when a fuel cell stack is electrically bypassed, it may be reconnected (block 110).

The method may further include any number of additional and optional steps, functions, processes, or variants thereof, including any disclosed relative to any other figure of this disclosure. For example, when the at least one fuel cell stack is electrically bypassed within the hydrogen fuel cell stack system, a hydration level of the electrically bypassed at least one fuel cell stack may be monitored. Monitoring the hydration level of the electrically bypassed at least one fuel cell stack may include determining the hydration level relative to a hydration threshold and, when the hydration level is less than the hydration threshold, executing a hydration recovery procedure.

Further, the method may include the hydrogen fuel cell stack system with fuel cell stacks electrically connected in series, where electrically bypassing at least one of the fuel cell stacks within the hydrogen fuel cell stack system removes the at least one fuel cell stack from being electrically connected in series. Electrically bypassing the at least one fuel cell stack within the hydrogen fuel cell stack system or electrically connecting the at least one fuel cell stack to the hydrogen fuel cell stack system may include the at least one fuel cell stack out of or into the hydrogen fuel cell stack system, respectively, using at least one solid-state or electro-mechanical switch. While the fuel cell voltages would be typically monitored continuously during all operating modes, the open circuit or low-current voltage is of special concern. Therefore, monitoring the fuel cell voltage of the hydrogen fuel cell stack system may occur during a period of low current draw. The hydrogen fuel cell stack system may power an aircraft. In this case, the period of low current draw may be during at least one of: startup, during taxiing, idling, or a throttle-back condition in flight.

The at least one fuel cell stack may be switched into a second hydrogen fuel cell stack system when the at least one fuel cell is electrically bypassed from the hydrogen fuel cell stack system, where the at least one fuel cell stack is connected electrically in parallel to the second hydrogen fuel cell stack system. Similarly, the at least one fuel cell stack may be switched into a load circuit when the at least one fuel cell stack is electrically bypassed from the hydrogen fuel cell stack system. When the hydrogen fuel cell stack system powers an aircraft, the method may include identifying a sustained power requirement of the aircraft and using a controller to activate a switching of the at least one fuel cell stack to a predetermined electrical configuration which is responsive to the identified sustained power requirement of the aircraft.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed is:

1. A method of dynamic fuel cell stack switching, the method comprising steps of:
monitoring a fuel cell voltage of a hydrogen fuel cell stack system; and
when the fuel cell voltage is outside a voltage range, adjusting the fuel cell voltage by:
electrically bypassing at least one fuel cell stack within the hydrogen fuel cell stack system; or
electrically connecting the at least one fuel cell stack to the hydrogen fuel cell stack system.

2. The method of claim 1, wherein when the at least one fuel cell stack is electrically bypassed within the hydrogen fuel cell stack system, and the hydration of the at least one bypassed fuel cell stack is monitored.

3. The method of claim 2, wherein monitoring the hydration level of the electrically bypassed at least one fuel cell stack further comprises:
determining the hydration level relative to a hydration threshold; and
when the hydration level is less than the hydration threshold, executing a hydration recovery procedure.

4. The method of claim 1, wherein the hydrogen fuel cell stack system further comprises fuel cell stacks electrically connected in series, and wherein electrically bypassing at least one of the fuel cell stacks within the hydrogen fuel cell stack system removes the at least one fuel cell stack from being electrically connected in series.

5. The method of claim 1, wherein electrically bypassing the at least one fuel cell stack within the hydrogen fuel cell stack system or electrically connecting the at least one fuel cell stack to the hydrogen fuel cell stack system further comprises switching the at least one fuel cell stack out of or into the hydrogen fuel cell stack system, respectively, using at least one solid-state or electro-mechanical switch.

6. The method of claim 1, wherein the bypassing of at least one fuel cell stack occurs during a period of low current draw.

7. The method of claim 6, wherein the hydrogen fuel cell stack system powers an aircraft, and wherein the period of low current draw further comprises at least one of: during startup, during taxiing, during idling, or during a throttle-back condition in flight.

8. The method of claim 6, wherein the period of low current draw is predicted using a machine learning method.

9. The method of claim 1, further comprising switching the at least one fuel cell stack into a second hydrogen fuel cell stack system when the at least one fuel cell is electrically bypassed from the hydrogen fuel cell stack system, wherein the at least one fuel cell stack is connected electrically in parallel to the second hydrogen fuel cell stack system.

10. The method of claim 1, further comprising switching the at least one fuel cell stack into a load circuit when the at least one fuel cell stack is electrically bypassed from the hydrogen fuel cell stack system.

11. The method of claim 1, wherein the hydrogen fuel cell stack system powers an aircraft, and wherein the method further comprises:
identifying a sustained power requirement of the aircraft; and
using a controller, activating a switching of the at least one fuel cell stack to a predetermined electrical configuration which is responsive to the identified sustained power requirement of the aircraft.

12. A system for dynamic fuel cell stack switching comprising:
a hydrogen fuel cell stack system having a plurality of fuel cell stacks;
a voltage monitoring sensor monitoring a fuel cell voltage of the hydrogen fuel cell stack system; and
a switch in electrical communication with the hydrogen fuel cell stack system, wherein when the fuel cell voltage is outside a voltage range, the switch is activated to:
electrically bypass at least one fuel cell stack within the hydrogen fuel cell stack system; or
electrically connect the at least one fuel cell stack to the hydrogen fuel cell stack system.

13. The system of claim 12, further comprising a hydration sensor in communication with the electrically bypassed at least one fuel cell stack, wherein when the at least one fuel cell stack is electrically bypassed within the hydrogen fuel cell stack system, the hydration sensor monitors a hydration level of the electrically bypassed at least one fuel cell stack.

14. The system of claim 13, wherein the hydration sensor senses the hydration level relative to a hydration threshold, and wherein, when the hydration level is less than the hydration threshold, a hydration recovery procedure is executed.

15. The system of claim 12, wherein the plurality of fuel cell stacks of the hydrogen fuel cell stack system are electrically connected in series, and wherein electrically bypassing the at least one of the fuel cell stacks within the hydrogen fuel cell stack system removes the at least one fuel cell stack from being electrically connected in series.

16. The system of claim 12, wherein the switch further comprises at least one solid-state or electro-mechanical switch.

17. The system of claim 12, wherein the fuel cell voltage is outside the voltage range during a period of low current draw.

18. The system of claim 17, wherein the hydrogen fuel cell stack system powers an aircraft, and wherein the period of low current draw further comprises at least one of: during startup, during taxiing, during idling, or during a throttle-back condition in flight.

19. The system of claim 12, further comprising one or both a second hydrogen fuel cell stack system, wherein the switch is activated to electrically bypass at least one fuel cell stack within the hydrogen fuel cell stack system and electrically connect, in parallel, the at least one fuel cell stack to the second hydrogen fuel cell stack system, and/or a load circuit, wherein the switch is activated to electrically bypass at least one fuel cell stack within the hydrogen fuel cell stack system and electrically connect the at least one fuel cell stack to the load circuit.

20. The system of claim 12, wherein the hydrogen fuel cell stack system powers an aircraft, and further comprising at least one controller, wherein the controller activates switching of the at least one fuel cell stack to a predetermined electrical configuration which is responsive to an identified sustained power requirement of the aircraft.
